(19) United States
(12) Patent Application Publication
(10) Pub. No.: US 2023/0281520 A1
(43) Pub. Date: Sep. 7, 2023

(54) SYSTEM AND METHOD TO SCHEDULE AN APPOINTMENT OR A RESERVATION USING A SCANNABLE CODE

(71) Applicant: VASUMITHRA THERLI, KAKINADA (IN)

(72) Inventor: VASUMITHRA THERLI, KAKINADA (IN)

(21) Appl. No.: 18/043,150

(22) PCT Filed: Oct. 20, 2020
(86) PCT No.: PCT/IB2020/059833

§ 371 Date: Feb. 27, 2023

(30) Foreign Application Priority Data
Sep. 4, 2020 (IN) 202041038202

(51) Int. Cl. G06Q 10/02; G06Q 10/1093; G06V 30/224

(52) U.S. Cl. CPC G06Q 10/02; G06Q 10/1095; G06V 30/224

(57) ABSTRACT

System and method to schedule an appointment or a reservation using at least one scannable code are provided. The system includes one or more processors; a registration module configured to register a plurality of service providers on the centralised platform; a scannable code generation module configured to generate at least one scannable code associated to the corresponding plurality of service providers; an appointment booking module configured to receive a requirement request from the corresponding plurality of customers to book an appointment, to analyse and predict an availability of the corresponding plurality of service providers to book the appointment, to book an appointment for the corresponding plurality of customers; an appointment recommendation module configured to receive a plurality of parameters, to analyse a suitable time slot and to generate an optimal recommendation for the corresponding plurality of customers with the corresponding plurality of service providers.

### CROSS-REFERENCE TO RELATED APPLICATION

This Application claims priority from a Patent application filed in India having Patent Application No. 202041038202, filed on Sep. 4, 2020, and titled “SYSTEM AND METHOD TO SCHEDULE AN APPOINTMENT OR A RESERVATION USING A SCANNABLE CODE” and a PCT Application No. PCT/IB2020/059833 filed on Oct. 20, 2020, and titled “SYSTEM AND METHOD TO SCHEDULE AN APPOINTMENT OR A RESERVATION USING A SCANNABLE CODE.”

### FIELD OF INVENTION

Embodiments of a present invention relate to scheduling an appointment, and more particularly, to a system and method to schedule an appointment or a reservation using a scannable code.

### BACKGROUND

Scheduling an appointment refers to book and manage appointments mostly for business and professional uses. Ideally, Businesses/Individuals schedule the meetings and appointments either by physically checking or via telecon, the availability of a user associated with the business or professional cause. In comparison with such ideal cases, a newer approach includes an application to book an appointment for the individuals. However, such newer approaches fail to consider the various factors such as environmental conditions, distance between a source and a destination locations and many more. In addition, the process involved in scheduling such appointments is very complex and time consuming. Such limitations make both the conventional and the newer approach less reliable and less efficient. Also, such approach has a complex way to share their availability, especially in physical locations like Business expos, Co-working spaces, Public Libraries and the like.

Hence there is a need for an improved system and method to schedule an appointment or a reservation using a scannable code to address the aforementioned issues.

### BRIEF DESCRIPTION

In accordance with one embodiment of the disclosure, a system to schedule an appointment or a reservation using at least one scannable code is provided. The system includes one or more processors. The system also includes a registration module operable by the one or more processors. The registration module is configured to register a plurality of service providers on the centralised platform upon receiving a plurality of service provider details. The system also includes a scannable code generation module operable by the one or more processors. The scannable module is configured to generate at least one scannable code associated to the corresponding plurality of service providers upon registering on the centralised platform. The system also includes an appointment booking module operable by the one or more processors. The appointment booking module is configured to receive a requirement request from the corresponding plurality of customers to book an appointment with the corresponding plurality of service providers at one or more time slots. The appointment booking module is also configured to analyse and predict an availability of the corresponding plurality of service providers to book the appointment for the corresponding plurality of customers at the one or more time slots based on the requirement request received. The appointment booking module is also configured to book an appointment for the corresponding plurality of customers at the preferred one or more time slots upon predicting the availability of the corresponding plurality of service providers and based on selection by the corresponding one or more customers by scanning the at least one scannable code via the centralised platform. The system also includes an appointment recommendation module operable by the one or more processors. The appointment recommendation module is configured to receive a plurality of parameters from a corresponding plurality of sources. The appointment recommendation module is also configured to analyse a suitable time slot for the corresponding plurality of customer to book the appointment with the corresponding plurality of service providers upon receiving the plurality of parameters. The appointment recommendation module is also configured to generate an optimal recommendation for the corresponding plurality of customers with the corresponding plurality of service providers to receive at least one corresponding service.

In accordance with another embodiment of the disclosure, a method for scheduling an appointment using at least one scannable code is provided. The method includes registering a plurality of service providers on the centralised platform upon receiving a plurality of service provider details. The method also includes generating at least one scannable code associated to the corresponding plurality of service providers upon registering on the centralised platform. The method also includes receiving a requirement request from the corresponding plurality of customers to book an appointment with the corresponding plurality of service providers at one or more time slots. The method also includes analysing and predicting an availability of the corresponding plurality of service providers to book the appointment for the corresponding plurality of customers at the one or more time slots based on the requirement request received. The method also includes booking an appointment for the corresponding plurality of customers at the preferred one or more time slots upon predicting the availability of the corresponding plurality of service providers and based on selection by the corresponding one or more customers by scanning the at least one scannable code via the centralised platform. The method also includes receiving a plurality of parameters from a corresponding plurality of sources. The method also includes analysing a suitable time slot for the corresponding plurality of customer to book the appointment with the corresponding plurality of service providers upon receiving the plurality of parameters. The method also includes generating an optimal recommendation for the corresponding plurality of customers with the corresponding plurality of service providers to receive at least one corresponding service.

### BRIEF DESCRIPTION OF THE DRAWINGS

The disclosure will be described and explained with additional specificity and detail with the accompanying figures in which:

FIG. 1 is a block diagram representation of a system to schedule an appointment or a reservation using at least one scannable code in accordance with an embodiment of the present disclosure;

FIG. 2 is a block diagram representation of an embodiment of the system to schedule an appointment with a doctor of FIG. 1 in accordance with an embodiment of the present disclosure;

FIG. 3 is a block diagram representation of a processor located on a local server or on a remote server in accordance with an embodiment of the present disclosure; and

FIG. 4a and FIG. 4b are flow charts representing steps involved in a method for scheduling an appointment using at least one scannable code in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment,

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to system and method to schedule an appointment or a reservation using at least one scannable code. As used herein, the term “appointment” is defined as an arrangement to meet someone at a particular time and place. Also, the term “scannable code” also referred as scan code is defined as a code via which data is visual represented in a machine-readable form. The visual representation may include a number, a sequence of numbers, a pattern of parallel lines, dots, dashes, or the like of varying widths arranged in a specific size and format. In one embodiment, the scannable code may include a one-dimensional code or a two-dimensional code. In one exemplary embodiment, the scannable code may include one of a bar code, a quick response (QR) code, a universal product codes (UPC) or the like.

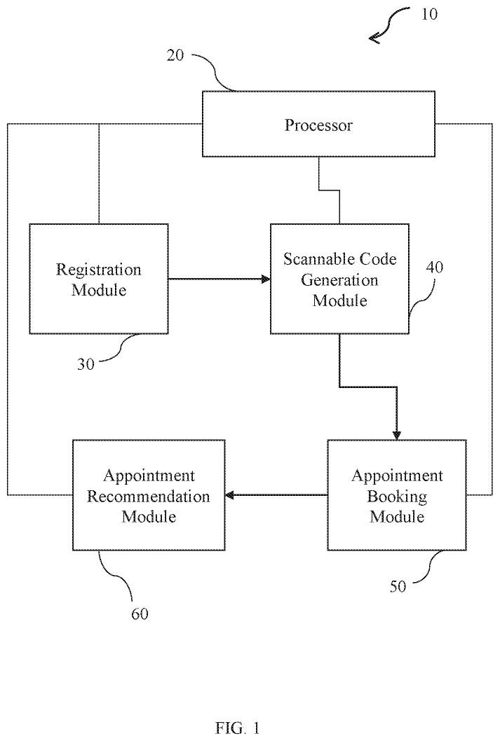

FIG. 1 is a block diagram representation of a system 10 to schedule an appointment or a reservation using at least one scannable code in accordance with an embodiment of the present disclosure. The system 10 includes one or more processors 20. The system 10 also includes a registration module 30 operable by the one or more processors 20. In one embodiment, the registration module 30 may be configured to register a plurality of customers on a centralised platform upon receiving a plurality of customer details. In one embodiment, the plurality of customer details may include name, age, gender, location, contact details and the like. In such embodiment, the plurality of customer details may be received via a corresponding customer device, wherein the customer device may include a display interface for the plurality of customers to view the availability of the corresponding plurality of service providers. In one specific embodiment, the customer device may correspond to a computing device such as a laptop, a mobile phone, a tablet or the like.

The registration module 30 is also configured to register a plurality of service providers on the centralised platform upon receiving a plurality of service provider details. In one embodiment, the plurality of service provider details may include name, age, gender, location, contact details, type of service being offered and the like. In such embodiment, the plurality of service provider details may be received via a corresponding service provider device, wherein the service provider device may include a display interface for the plurality of service providers to provide the availability of the corresponding plurality of service providers. In one specific embodiment, the service provider device may correspond to a computing device such as a laptop, a mobile phone, a tablet or the like. In operation, the plurality of customers and the plurality of service providers registers on a centralised platform, to project the availability and the requirements respectively in order to book and manage the appointments. In one exemplary embodiment, the type of service may include one of a one on one appointment, reservation of table in a restaurant, reservation a hotel room, a services, a group bookings, a virtual meetings, a product purchase, a room booking like a conference room, a meeting rooms, or a combination thereof.

Furthermore, the system 10 includes a scannable code generation module 40 operable by the one or more processors 20. The scannable code generation module 40 is configured to generate at least one scannable code associated to the corresponding plurality of service providers upon registering on the centralised platform. More specifically, upon registration of the plurality of service providers, a unique generate at least one scannable code will be automatically generated by the system 10. The at least one scannable code may be randomly generated by the system. In one embodiment, the unique code in the form of the corresponding at least one scannable code may be generated upon applying a set of instructions or a unique formula on platform to create a text value or a numeric value, which is further assigned to a dynamic value of a designated field. In such embodiment, the unique code may be generated upon providing the required set of details in a pre-defined format. Moreover, upon generating the at least one scannable code, one or more of the plurality of service provider details are synced with the corresponding at least one scannable code. The one or more of the plurality of service provider details to be synced with the at least one scannable code may be pre-defined by the corresponding plurality of service providers. Further, the unique code is represented as the corresponding scannable code in order to enable easy access the plurality of details associated with the corresponding at least one scannable code. In such embodiment, the plurality of service provider details to be available on scanning the at least one scannable code may be updated on the centralised platform in real time.

In one exemplary embodiment, the plurality of service provider details which may be displayed on the display interface of the customer device may include one or more of the availability of the plurality of service provider in terms of time and duration, one or more services provided by the corresponding plurality of service providers, location of service being provided by the corresponding plurality of service provider, and the like.

The system 10 also includes an appointment booking module 50 operable by the one or more processors 20. The appointment booking module 50 is configured to receive a requirement request from the corresponding plurality of customers to book an appointment or schedule a reservation with the corresponding plurality of service providers at one or more time slots upon scanning the at least one scannable code via the centralised platform. In one embodiment, the appointment for the corresponding services may be approached by the corresponding at least one customer upon scanning the corresponding at least one scannable code.

The appointment booking module 50 is also configured to analyse and predict an availability of the corresponding plurality of service providers to book the appointment or schedule the reservation for the corresponding plurality of customers at the one or more time slots based on the requirement request received. In one embodiment, the requirement request may be received on the centralised platform based on the scanning of the at least one scannable code by the corresponding plurality of customers. In one embodiment, the one or more slots of the plurality of service providers may be generated and managed by the plurality of service providers manually. In another embodiment, a pre-scheduled appointment of the corresponding plurality of service providers may be synced with the plurality of service provider details in order to predict and analyse the availability of the corresponding plurality of service providers. In such embodiment, the pre-scheduled appointments of the plurality of service providers may be retrieved by one of a message, an e-mail, a calendar, or the like upon availing the access by the plurality of service providers to sync the details with a database associated with the centralised platform.

The appointment booking module 50 is further configured to book an appointment or schedule the reservation for the corresponding plurality of customers at the preferred one or more time slots upon predicting the availability of the corresponding plurality of service providers and based on selection by the corresponding one or more customers by scanning the at least one scannable code via the centralised platform, Referring to the previously described embodiment, the availability of the plurality of service providers may be provided by the centralised platform upon analysing and predicting the availability of the plurality of service providers in terms of the one or more slots; further to which the plurality of customers may select one of the one or more slots based on their availability and requirements via the display interface from the customer device.

Furthermore, the system 10 includes an appointment recommendation module 60 operable by the one or more processors 20. The appointment recommendation module 60 is configured to receive a plurality of parameters from a corresponding plurality of sources. In one embodiment, the plurality of parameters may one of weather forecast, traffic level, distance between customer location and service provider location, slot at which the appointment or the reservation needs to be fixed or a combination thereof. In one embodiment, the plurality of sources may include one of an internal source, an external source or the combination thereof, wherein the plurality of parameters may be retrieved from the corresponding plurality of sources. In one embodiment, the internal source may include the database associated with the centralised platform. In another embodiment, the external source may include one or more external databases associated to at least one of the plurality of parameters which are not be maintained by the centralised platform of the system. In such embodiment, the one or more external sources may include one of a weather forecast database, traffic management database; global positioning system (GPS) database, and the like. The one or more external sources may be integrated with the centralised platform for accurate prediction and management of the appointment of the plurality of customers with the corresponding plurality of service providers.

On receiving the plurality of parameters from the plurality of sources, the same is analysed by the system and further, the appointment recommendation module 60 is configured to generate an optimal recommendation for the corresponding plurality of customers with the corresponding plurality of service providers to receive at least one corresponding service. More specially, on analysing the plurality of parameters, the requirements of the plurality of customers, the availability of the plurality of service providers; the appointment recommendation module 60 may generate the optimal recommendation representative of the appointment booking for the plurality of customers with the corresponding plurality of service provider which may be optimal for both the customer and the service providers. In one specific embodiment, the recommendation may be generated by the appointment recommendation module 60 in real time, henceforth the recommendation may vary based on the plurality parameters, the requirements of the plurality of customers, the availability of the plurality of service providers, and the like.

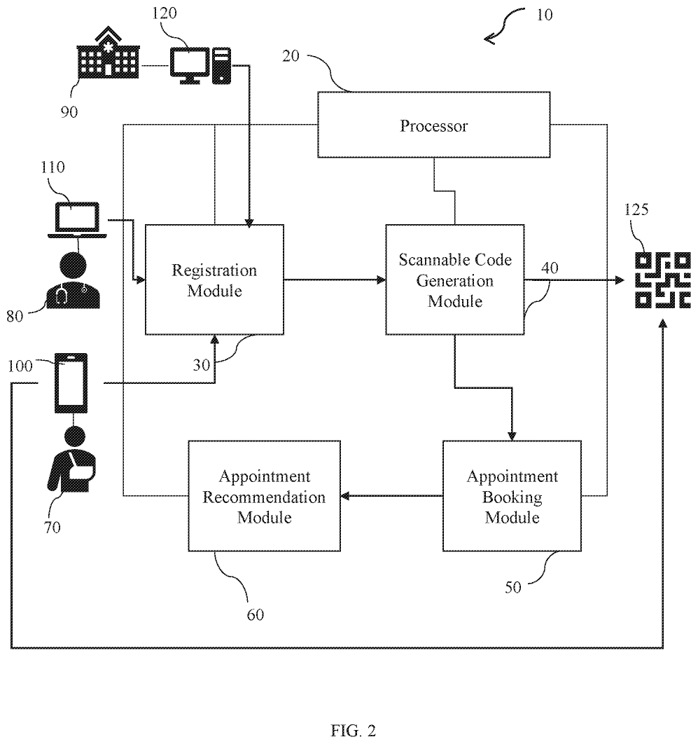

FIG. 2 is a block diagram representation of an embodiment of the system 10 to schedule an appointment with a doctor of FIG. 1 in accordance with an embodiment of the present disclosure. A patient ‘X’ 70 wants to book an appointment with a doctor ‘Y’ 80 at a hospital ‘Z’ 90. Firstly, the hospital ‘Z’ 90, the doctor ‘Y’ 80 and the patient ‘X’ 70 registers on the centralised platform upon providing a plurality of hospital details, a plurality of doctor details and a plurality of patient details via a hospital device 120, a doctor device 110 and a patient device 100 respectively by the registration module 30. Upon registration, a QR code 125 is generated by the scannable code generation module 40.

Further, the plurality of parameters associated to the hospital ‘Z’ 90 and the doctor ‘Y’ 80 is acquired from multiple sources, in order to determine the availability of the doctor ‘Y’ 80. Further, as the patient ‘X’ 70 scans the QR code 125 via the patient device 100. Upon scanning the QR code 125, the centralised platform leads the patient ‘X’ 70 to a page where the patient ‘X’ 70 can view the availability of appointments for the doctor ‘Y’ 80 in real time. On getting a satisfactory date and time, the patient ‘X’ 70 selects and transmits the requirement request through the appointment booking module 50. The request is further analysed and predicted if the requested time slot matches the requirements of both the patient ‘X’ 70 and the doctor ‘Y’ 80. On generating a positive result, the centralised platform book and confirms the appointment for the patient ‘X’ 70. Also, on the date of appointment, the multiple parameters are analysed by the appointment recommendation module 60 and generates another optimum time slot for the patient ‘X’ 70 to fix the appointment with the doctor 80 in case the booked slot is not feasible for the patient ‘X’ 70 for a reason of traffic jam between the location of patient ‘X’ 70 to the hospital ‘Z’ 90. The optimum time slot is transmitted to the patent ‘X’ 70 and the doctor ‘Y’ 80 accordingly.

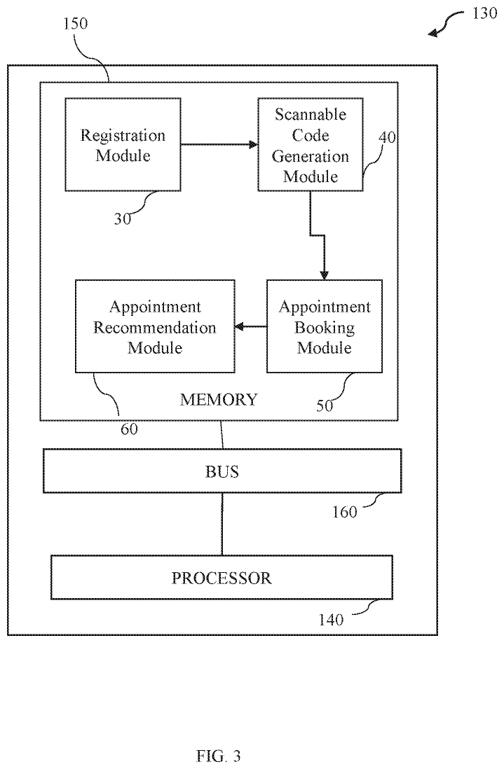

FIG. 3 is a block diagram representation of a processor 130 located on a local server or on a remote server in accordance with an embodiment of the present disclosure. The server 130 includes processor(s) 140, and memory 150 operatively coupled to the bus 160.

The processor(s) 140, as used herein, means any type of computational circuit, such as, but not limited to, a microprocessor; a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

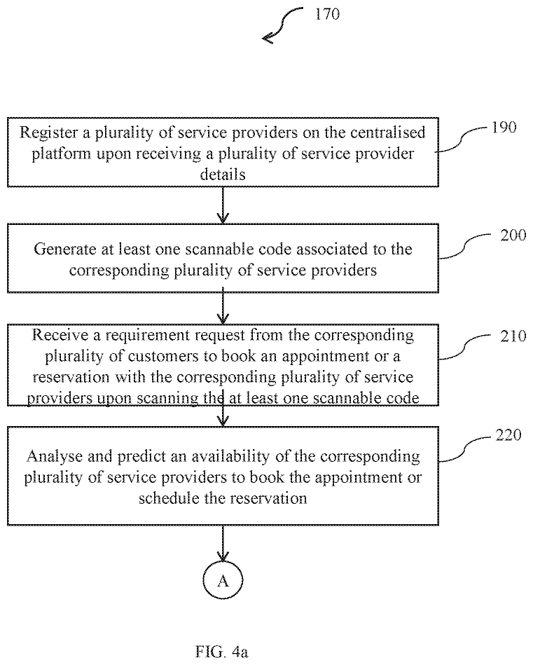

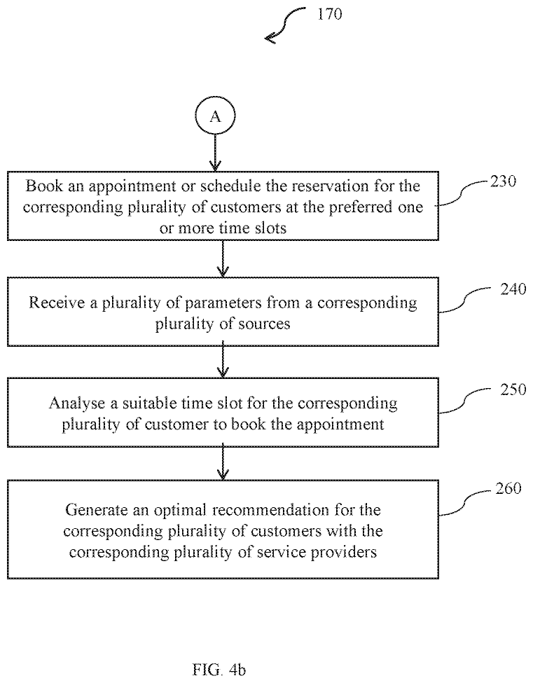

The memory 150 includes a plurality of modules stored in the form of executable program which instructs the processor 140 to perform the method steps illustrated in FIG. 4a and FIG. 4b. The memory 150 is substantially similar to the system 10 of FIG. 1. The memory 150 has the following modules: a registration module 30, a scannable code generation module 40, an appointment booking module 50 and an appointment recommendation module 60.

The registration module 30 is configured to register a plurality of customers on a centralised platform upon receiving a plurality of customer details and to register a plurality of service providers on the centralised platform upon receiving a plurality of service provider details.

The scannable code generation module 40 is configured to generate at least one scannable code associated to the corresponding plurality of service providers upon registering on the centralised platform.

The appointment booking module 50 is configured to receive a requirement request from the corresponding plurality of customers to book an appointment with the corresponding plurality of service providers at one or more time slots; to analyse and predict an availability of the corresponding plurality of service providers to book the appointment for the corresponding plurality of customers at the one or more time slots based on the requirement request received; and to book an appointment for the corresponding plurality of customers at the preferred one or more time slots upon predicting the availability of the corresponding plurality of service providers and based on selection by the corresponding one or more customers by scanning the at least one scannable code via the centralised platform.

The appointment recommendation module 60 is configured to receive a plurality of parameters from a corresponding plurality of sources; to analyse a suitable time slot for the corresponding plurality of customer to book the appointment or schedule the reservation with the corresponding plurality of service providers upon receiving the plurality of parameters; and to generate an optimal recommendation for the corresponding plurality of customers with the corresponding plurality of service providers to receive at least one corresponding service.

FIG. 4a and FIG. 4b are flow charts representing steps involved in a method 170 for scheduling an appointment or a reservation using at least one scannable code in accordance with an embodiment of the present disclosure. In one exemplary embodiment, the method 170 may include registering a plurality of customers on a centralised platform upon receiving a plurality of customer details. In one embodiment, registering the plurality of customers may include registering the plurality of customers by a registration module. In one exemplary embodiment, registering the plurality of customers may include registering the plurality of customers on the centralised platform upon receiving name, age, gender, location, contact details and the like of the corresponding plurality of customers.

The method 170 includes registering a plurality of service providers on the centralised platform upon receiving a plurality of service provider details in step 190. In one embodiment, registering the plurality of service providers may include registering the plurality of service providers by the registration module. In one exemplary embodiment, registering the plurality of service providers may include registering the plurality of service providers on the centralised platform upon receiving age, gender, location, contact details, type of service being offered and the like of the corresponding plurality of service providers.

Furthermore, the method 170 includes generating at least one scannable code associated to the corresponding plurality of customers upon registering on the centralised platform in step 200. In one embodiment, generating the at least one scannable code may include generating the at least one scannable code by a scannable code generation module. In one exemplary embodiment, generating the at least one scannable code may include generating a one-dimensional code or a two-dimensional code. In one exemplary embodiment, generating the at least one scannable code may include generating one of a bar code, a quick response (QR) code, a universal product codes (UPC) or the like.

The method 170 also includes receiving a requirement request from the corresponding plurality of customers to book an appointment with the corresponding plurality of service providers at one or more time slots upon scanning the at least one scannable code in step 210. In one embodiment, receiving the requirement request may include receiving the requirement request by, an appointment booking module, In one exemplary embodiment, the method 170 may include scanning the at least one scannable code by the customer via the customer device. The method 170 may further include selecting the one or more slots available to book the appointment with the corresponding plurality of service providers.

The method 170 also includes analysing and predicting an availability of the corresponding plurality of service providers to book the appointment or schedule the reservation for the corresponding plurality of customers at the one or more time slots based on the requirement request received in step 220. In one embodiment, analysing and predicting the availability of the corresponding plurality of service providers may include analysing and predicting the availability of the corresponding plurality of service providers by the appointment booking module.

Furthermore, the method 170 includes booking an appointment for the corresponding plurality of customers at the preferred one or more time slots upon predicting the availability of the corresponding plurality of service providers and based on selection by the corresponding one or more customers by scanning the at least one scannable code via the centralised platform in step 230. In one embodiment, booking the appointment for the corresponding plurality of customers may include booking the appointment for the corresponding plurality of customers by the appointment booking module.

The method 170 also includes receiving a plurality of parameters from a corresponding plurality of sources in step 240. In one embodiment, receiving the plurality of parameters may include receiving the plurality of parameters by an appointment recommendation module. In one exemplary embodiment, receiving the plurality of parameters may include receiving one of weather forecast, traffic level, distance between customer location and service provider location, slot at which the appointment needs to be fixed or a combination thereof. In such embodiment, receiving the plurality of parameters may include receiving the plurality of parameters from one of an internal source, an external source, or a combination thereof.

The method 170 further includes analysing a suitable time slot for the corresponding plurality of customers to book the appointment with the corresponding plurality of service providers upon receiving the plurality of parameters in step 250. In one embodiment, analysing the suitable time slot for the corresponding plurality of customers includes analysing the suitable time slot for the corresponding plurality of customers by the appointment recommendation module.

Furthermore, the method 170 includes generating an optimal recommendation for the corresponding plurality of customers with the corresponding plurality of service providers to receive at least one corresponding service in step 260. In one embodiment, generating the optimal recommendation for the corresponding plurality of customers may include generating the optimal recommendation for the corresponding plurality of customers by the appointment recommendation module.

In one exemplary embodiment, the method 170 may further include generating a notification representative of the booking of the appointment for the plurality of customers with the corresponding plurality of service providers based on the analysis, prediction and booking of the appointment. In such embodiment, generating the notification may include generating one of a text notification, a voice notification, a video notification, or the like.

Various embodiments of the present disclosure enable the system to book appointment, reservations and meetings just by scanning the scannable code which is unique to all service providers. Also, the system considers various other factors such as weather, traffic condition and the like while scheduling the appointment, thereby making the system more efficient and more reliable. Since the system is integrated with many other sources, the approach of the system is very, simple and henceforth less time consuming. Also, as the system is managed at a central processing level, the hardware utilization of the system and the operating speed is less, thereby making the system more technically advanced.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element, Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

I claim:

1. A system to schedule an appointment or a reservation using at least one scannable code comprising:
one or more processors;
a registration module operable by the one or more processors; and configured to register a plurality of service providers on the centralised platform upon receiving a plurality of service provider details;
a scannable code generation module operable by the one or more processors, and configured to generate at least one scannable code associated to the corresponding plurality of service providers upon registering on the centralised platform;
an appointment booking module operable by the one or more processors, and configured to:
receive a requirement request from the corresponding plurality of customers to book an appointment or schedule a reservation with the corresponding plurality of service providers at one or more time slots upon scanning the at least one scannable code via the centralised platform;
analyse and predict an availability of the corresponding plurality of service providers to book the appointment for the corresponding plurality of customers at the one or more time slots based on the requirement request received; and
book an appointment for the corresponding plurality of customers at the preferred one or more time slots upon predicting the availability of the corresponding plurality of service providers and based on selection by the corresponding one or more customers by scanning the at least one scannable code via the centralised platform;
an appointment recommendation module operable by the one or more processors, and configured to:
receive a plurality of parameters from a corresponding plurality of sources;
analyse a suitable time slot for the corresponding plurality of customer to book the appointment or schedule the reservation with the corresponding plurality of service providers upon receiving the plurality of parameters; and
generate an optimal recommendation for the corresponding plurality of customers with the corresponding plurality of service providers to receive at least one corresponding service.

2. The system as claimed in claim 1, wherein the plurality of customer details is received via a corresponding customer device, wherein the customer device comprises a display interface for the plurality of customers to view the availability of the corresponding plurality of service providers.

3. The system as claimed in claim 1, wherein the at least one scannable code comprises one of a one dimensional code or a two-dimensional code.

4. The system as claimed in claim 1, wherein the plurality of parameters comprises one of weather forecast, traffic level, distance between customer location and service provider location, slot at which the appointment needs to be fixed or a combination thereof.

5. The system as claimed in claim 1, wherein the service offered by the plurality of service providers comprises one of a one on one appointment, reservation of table in a restaurant, reservation a hotel room, a services, a group bookings, a virtual meetings, a product purchase, a room booking like a conference room; a meeting rooms; or a combination thereof.

6. A method for scheduling an appointment using at least one scannable code comprising
registering, by the registration module, a plurality of service providers on the centralised platform upon receiving a plurality of service provider details;
generating, by a scannable code generation module, at least one scannable code associated to the corresponding plurality of customers upon registering on the centralised platform;
receiving, by an appointment booking module, a requirement request from the corresponding plurality of customers to book an appointment with the corresponding plurality of service providers at one or more time slots upon scanning the at least one scannable code;
analysing and predicting, by the appointment booking module, an availability of the corresponding plurality of service providers to book the appointment for the corresponding plurality of customers at the one or more time slots based on the requirement request received;
booking, by the appointment booking module, an appointment or scheduling a reservation for the corresponding plurality of customers at the preferred one or more time slots upon predicting the availability of the corresponding plurality of service providers and based on selection by the corresponding one or more customers by scanning the at least one scannable code via the centralised platform;
receiving, by an appointment recommendation module, a plurality of parameters from a corresponding plurality of sources;
analysing, by the appointment recommendation module, a suitable time slot for the corresponding plurality of customer to book the appointment or schedule the reservation with the corresponding plurality of service providers upon receiving the plurality of parameters; and
generating, by the appointment recommendation module, an optimal recommendation for the corresponding plurality of customers with the corresponding plurality of service providers to receive at least one corresponding service.

7. The method as claimed in claim 6, wherein registering the plurality of customer details comprises receiving the plurality of customers via a corresponding customer device, wherein the customer device comprises a display interface for the plurality of customers to view the availability of the corresponding plurality of service providers.

8. The method as claimed in claim 6, wherein generating the at least one scannable code comprises generating one of a one dimensional code or a two-dimensional code.

9. The method as claimed in claim 6, wherein receiving the plurality of parameters comprises receiving one of weather forecast, traffic level, distance between customer location and service provider location, slot at which the appointment needs to be fixed or a combination thereof.

10. The method as claimed in claim 6, wherein providing the service comprises providing at least one service includes one of a one on one appointment, reservation of table in a restaurant, reservation a hotel room, a services, a group bookings, a virtual meetings, a product purchase, a room booking like a conference room, a meeting rooms, or a combination thereof.
